(19) United States
(12) Patent Application Publication
(10) Pub. No.: US 2026/0264279 A1
(43) Pub. Date: Sep. 10, 2026

(54) KNIFE WITH COMPOSITE BLADE STEEL

(71) Applicant: BENCHMADE KNIFE CO., INC., Oregon City, OR (US)

(72) Inventors: Eugene Kohout, Oregon City, OR (US); James Dobbs, Oregon City, OR (US); Dan Yates, Oregon City, OR (US)

(21) Appl. No.: 19/409,566

(22) Filed: Dec. 4, 2025

Related U.S. Application Data
(60) Provisional application No. 63/767,305, filed on Mar. 5, 2025.

(51) Int. Cl. B26B 9/00; B26B 1/02; B26B 3/00; C23C 24/10

(52) U.S. Cl. CPC B26B 9/00; C23C 24/106; B26B 1/02; B26B 3/00

(57) ABSTRACT

A knife blade has different edge regions with different compositions. The different edge regions allow for different materials on the same edge of the blade, such as the lower edge. The different materials can vary in terms of characteristics such as hardness, toughness/brittleness, corrosion resistance, formability, ease of manufacturing and availability. The solutions provide a correspondence between the selected materials and/or geometry of the different edge regions of the blade and the intended uses and functions of the regions, to optimize the performance of the knife.

### CROSS-REFERENCE TO RELATED APPLICATIONS

This application claims the benefit of U.S. provisional patent application No. 63/767,305, filed Mar. 5, 2025, titled “KNIFE WITH COMPOSITE BLADE STEEL,” and incorporated herein by reference.

### TECHNICAL FIELD

The present disclosure relates to the field of knives, and specifically to a knife with different edge regions with different compositions.

### BACKGROUND

Knives are available in a variety of designs as required for various purposes. Generally, knives can be configured with either a fixed blade or a folding blade. Fixed blade knives are more suitable for heavy duty cutting tasks while folding knives are more compact. However, the design of a knife often results in compromises.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 depicts a first example knife 100 having a blade 110 with edge regions 111 and 112 with a first metal composition, and edge regions 113 and 114 with a second metal composition, and a handle 150, in accordance with various embodiments.

FIG. 2 depicts a second example knife 200 having a blade 210 with a straight edge region 212 and a belly edge region 214 with different metal compositions, and a handle 250, in accordance with various embodiments.

FIG. 3 depicts a third example knife 300 having a blade 310 with a recurve edge region 312 and a belly edge region 314 with different metal compositions, and a handle 350, in accordance with various embodiments.

FIG. 4 depicts a fourth example knife 400 having a blade 410 with a straight edge region 412 and a tanto tip edge region 414 with different metal compositions, and a handle 450, in accordance with various embodiments.

FIG. 5A depicts a fifth example knife 500 having a blade 510 with a straight edge region 512 and a belly edge region 514 with different metal compositions, and a handle 550, in accordance with various embodiments.

FIG. 5B depicts a variation on the example knife 500 of FIG. 5A, where the belly edge region 514 of the blade has a different metal composition than the main body 560 of the blade, and a straight edge region 512A has a same material as the main body 560 of the blade, in accordance with various embodiments.

FIG. 6 depicts a sixth example knife 600 having a blade 610 with a straight edge region 612, a belly edge region 614, and a chisel tip edge region 616 with different metal compositions, and a handle 650, in accordance with various embodiments.

FIG. 7 depicts a first example method for fabricating a knife blade with edge regions with different metal compositions in accordance with various embodiments.

FIG. 8 depicts a second example method for fabricating a knife blade with edge regions with different metal compositions in accordance with various embodiments.

FIG. 9 depicts a third example method for fabricating a knife blade with edge regions with different metal compositions in accordance with various embodiments.

FIG. 10 depicts a fourth example method for fabricating a knife blade with edge regions with different metal compositions in accordance with various embodiments.

FIG. 11 depicts a table of example knife blade materials with respective properties including edge retention, toughness, hardness, and corrosion resistance, in accordance with various embodiments.

### DETAILED DESCRIPTION

In the following detailed description, reference is made to the accompanying figures which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

As mentioned at the outset, the design of a knife often results in compromises, especially in terms of the blade. The designer can select the blade shape and size and edge characteristics but is typically limited to using a single blade material.

The solutions described herein address the above and other issues. In one aspect, a blade is provided that has different edge regions with different compositions. The different edge regions allow for different materials on the same edge of the blade, such as the lower edge. The different materials can vary in terms of characteristics such as hardness, toughness/brittleness, corrosion resistance, formability, ease of manufacturing and availability. Techniques are provided for manufacturing the blades with a desired material along the edge, including using laser metal deposition.

When evaluating different materials for a knife blade, there are performance tradeoffs that have to be assessed. Hardness is a good indicator of a material's wear resistance. Harder materials will provide a longer life, but are more brittle and prone to cracking or chipping. A harder metal tends to hold an edge better than a softer metal. Tougher materials are less likely to chip or crack, but will typically wear more quickly. Corrosion resistance is the ability to withstand discoloration or oxidization damage. Formability involves the difficulty in forming the material into the desired final shape. Ease of manufacturing involves the difficulty in machining the material. Availability accounts for factors such as cost and the difficulty of sourcing the material.

In an example implementation, a region at the front of the blade has a higher hardness and therefore edge retention than a region at the rear of the blade.

In an example implementation, the blade has a cutting edge with two, three or potentially more regions of different materials.

In an example implementation, the materials can include single-alloy metals, such as a different type of steel in each region.

The solutions optimize the materials of the different edge regions for their intended use, e.g., fine slicing at the front of the bladed versus pull cutting at the rear of the blade.

In another possible implementation, different coatings are applied to the different edge regions of the blade so that the regions are optimized for different uses.

In another possible implementation, a different geometry, e.g., grind and/or blade angle, can be used in the different edge regions so the angle is optimized for the intended use of the region.

The solutions provide a correspondence between the selected materials and/or geometry of the different edge regions of the blade and the intended uses and functions of the regions, to optimize the performance of the knife.

The above and other advantages will be further apparent in view of the following discussion.

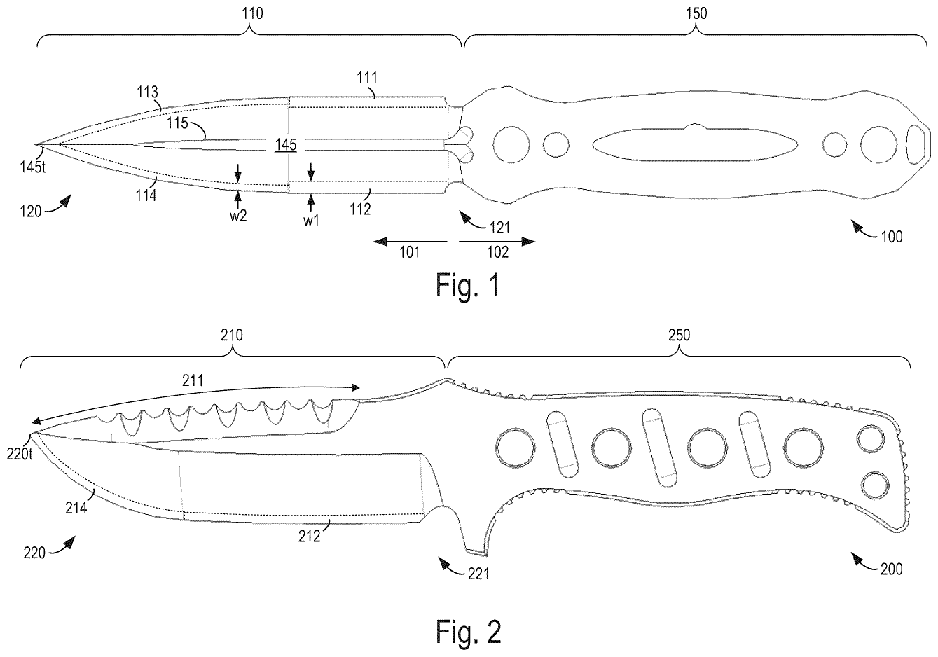

FIG. 1 depicts a first example knife 100 having a blade 110 with edge regions 111 and 112 with a first metal composition, and edge regions 113 and 114 with a second metal composition, and a handle 150, in accordance with various embodiments. The first and second metal compositions can be different from one another and different than a third metal composition of the main body 145, e.g., the remainder, of the blade. The first and second metal compositions can be provided by a treatment of the edge of the main body of the blade. The edge regions 113 and 114 are at the front 120 of the blade, and the edge regions 111 and 112 are at the rear 121 of the blade. The front of the blade 110 includes a pointed tip 145t and the back or rear of the blade 121 is attached to the handle, either permanently, in this example, or on a pivot axis, to allow folding. The frontward direction is a direction toward the tip of the blade (arrow 101) and the rearward direction is the opposite direction, toward the back of the blade (arrow 102).

The boundaries of the edge regions with the different metal compositions are depicted by dotted lines. The edge regions can have a width which extends a few millimeters from the blade edge. The different edges regions can have the same or different widths. For example, the edge regions 112 and 114 have widths w1 and w2, respectively, where w1>w2. The example herein depicts fixed-bladed knives, but folding knives could be used as well. The regions 113 and 114 are frontward of the regions 111 and 112, respectively.

The knife is a double edge spear point style, with a central fuller 115, and includes opposing straight edges 111 and 112, and opposing belly edges 113 and 114. A fuller is a rounded or beveled longitudinal groove or slot along the flat side of a blade that serves to both lighten and stiffen the blade. A belly edge is the curving part of a blade's edge.

Generally, a curved edge of a blade is suited for rocking motions, such as chopping, mincing, and cutting through softer materials, while a straight edge is suited for precise cuts with minimal deviation, including delicate tasks such as skinning or carving, pull cuts and precise cutting of sheets of material.

The different metal compositions can be tailored to the different purposes of the different edges of the blades, in one approach. For instance, the blade belly edge can be formed of a material such as S90V which provides very high edge retention, while the straight edge can be formed of a material such as 3V or M4 steel.

S90V, also referred to as CPM® S90V (420V), is a premium-grade, powder metallurgy stainless steel produced by Crucible Industries, Syracuse, New York. It is a martensitic stainless steel to which vanadium and carbon have been added for exceptionally good wear resistance. CPM® S90V (420V) corresponds to AISI 420 modified with high vanadium. AISI steel refers to steel that is graded by the American Iron and Steel Institute (AISI). AISI numbers are used to identify the grade of steel and the amount of carbon in it.

Steel is rated for its ability to hold a sharp edge based on its hardness, which is measured on the Rockwell C scale (HRC); generally, the higher the HRC value, the better the steel will retain its edge, but also the more brittle it will be, meaning a higher risk of chipping if not handled carefully. Higher carbon content in steel leads to increased hardness and better edge retention. A preferred hardness range is about 58-62 HRC, providing a good balance between edge retention and toughness. Steels with added vanadium often have exceptional edge retention due to their wear resistance.

In one approach, the edges 113 and 114 have a higher edge retention, e.g., a higher HRC, than the edges 111 and 112.

3V tool steel refers to a high-speed tool steel grade designated as “HS6-5-3C” or “1.3345” in the DIN (Deutsches Institut für Normung or German Institute for Standardisation) standard, known for its good wear resistance, toughness, and edge stability. Its properties include high toughness, good wear resistance, good edge stability, and high grindability.

M4 tool steel is a high-speed steel with high carbon and vanadium content. M4's high carbon and vanadium content gives it excellent abrasion resistance. M4's fine grain size and small carbides give it high impact toughness and bend strength. M4's tungsten, molybdenum, and vanadium content help it withstand high temperatures. M4's chromium and carbon content improve its overall strength and durability

Other names include CPM® REX M4 steel (Crucible Industries), ASP® 2004 (Air Sintered Powder, available from Erasteel Alloys GmbH, Erkelenz, Germany), S690 (a steel with a minimum yield strength of 690 MPa), and PM M4.

Generally, many different types of blade steels can be used. One example is Martensitic Stainless Steels (MSS)-defined as 400-series stainless steels in the SAE steel grades numbering system. Hardness can be increased through heat treatment.

Another example is Low Carbon MSS (LCMSS)—General purpose grade, low hardness, high toughness, ease of manufacture, e.g., 420 series.

Another example is High Carbon MSS (HCMSS)—high hardness with reduced toughness, wear resistance, e.g., 440C.

Another example is High Carbon, High Alloy MSS (HAMSS)—Special purpose, high hardness, high wear resistance, 420V (S90V).

Another example is Tool Steels (TS)—defined as carbon steels and alloy steels that are particularly well suited to be made into tools due to their hardenability, resistance to abrasion and deformation, and the ability to hold a cutting edge at elevated temperatures. TS is generally regarded as non-stainless.

Another example is High Cabon Chromium TS (HCCTS)—“D” series, high wear resistance, moderate toughness, high hardness at elevated working temperatures i.e D2.

Another example is Shock Resistant TS (SRTS)—Low carbon, high toughness, moderate alloy for increased wear resistance, e.g., 3V.

Another example is High-speed TS (HSS—High Speed Steel)—high carbon, high alloy, high hardness at extreme working temperatures, high wear resistance, moderate to low toughness, e.g., M4.

FIG. 2 depicts a second example knife 200 having a blade 210 with a straight edge region 212 and a belly edge region 214 with different metal compositions, and a handle 250, in accordance with various embodiments. The blade is a double-edge drop point blade with a serrated spine 211 and a drilled handle area with texture notches and finger guard. The blade includes the straight edge region 212 and the belly edge region 214 on the bottom side, and a serrated spine 211 on the top side. The belly edge region 214 is at the front 220 of the blade, and the belly edge region 212 is at the rear 221 of the blade.

In one approach, the belly edge region 214 has a higher edge retention than the straight edge region 212. The belly edge region 214 is frontward of the straight region 212, and closer to the tip 220t of the blade.

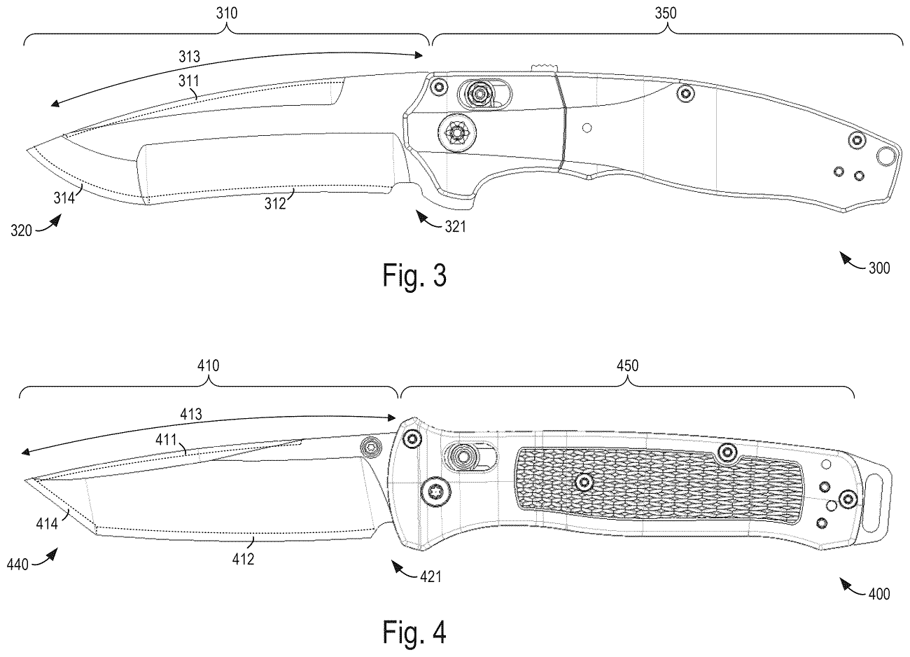

FIG. 3 depicts a third example knife 300 having a blade 310 with a recurve edge region 312 and a belly edge region 314 with different metal compositions, and a handle 350, in accordance with various embodiments. The knife is an assisted flipper knife with a drop point blade and an integrated safety. The blade includes the recurve edge region 312 (a concave curved edge) with a more acute angle and the belly edge region 314 on the bottom side, and spine 313 with a swedge 311 or unsharpened bevel on the top side.

The edge region 314 is at the front 320 of the blade, and the edge region 312 is at the rear 321 of the blade. The belly edge region 314 is frontward of the recurve edge region 312.

In an example implementation, which is suitable for a so-called every day carry (EDC) knife, the blade belly is made of S90V for very high edge retention, and the recurve acute angle edge is made of M4 tool steel to provide a slicing edge with high toughness and edge retention.

In one approach, the belly edge region 314 has a higher edge retention than the recurve edge region 312.

FIG. 4 depicts a fourth example knife 400 having a blade 410 with a straight edge region 412 and a tanto tip edge region 414 with different metal compositions, and a handle 450, in accordance with various embodiments. The knife is a tactical EDC knife with a tanto tip (a sharp, angled tip designed for piercing and stabbing) and a top swedge 411.

The blade includes the straight edge region 412 and the tanto tip edge region 414 on the bottom side, and a spine 413 with a swedge 411 on the top side.

The tanto tip edge region 414 is at the front 440 of the blade, and the straight edge region 412 is at the rear 421 of the blade. The tanto tip edge region 414 is frontward of the straight edge region 412.

In an example implementation, the tanto tip edge region 414 is made of 3V tool steel for extreme toughness and for possibly for other tasks such as prying, and the straight edge region 412 is made of M4 tool steel for high toughness and edge retention.

In one approach, the tanto tip edge region 414 has a higher edge retention than the straight edge region 412.

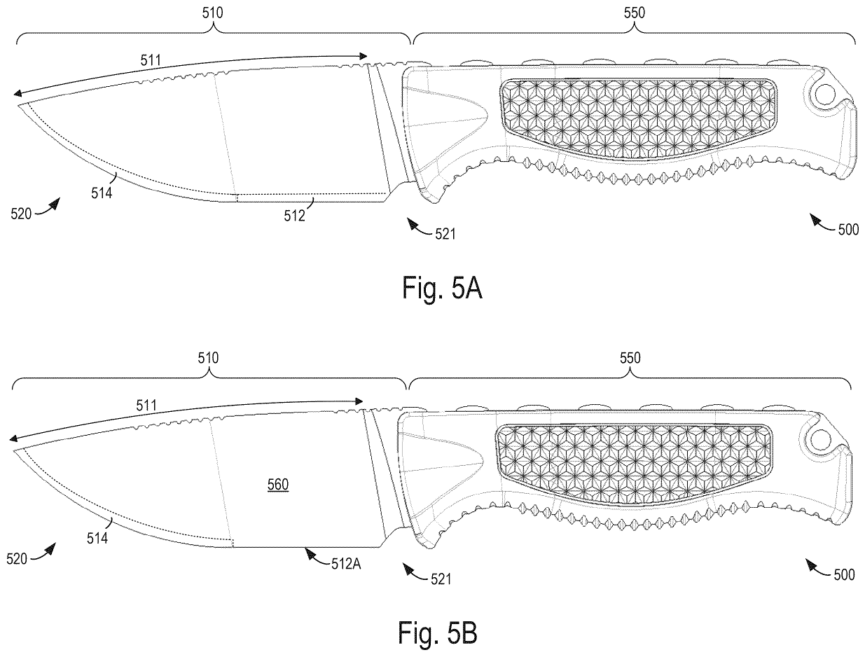

FIG. 5A depicts a fifth example knife 500 having a blade 510 with a straight edge region 512 and a belly edge region 514 with different metal compositions, and a handle 550, in accordance with various embodiments. The knife has a drop point blade and is suitable for hunting or bush crafting applications.

The blade includes the straight edge region 512 and the belly edge region 514 on the bottom side, and a notched spine 511 on the top side.

The belly edge region 514 is at the front 520 of the blade, and the straight edge region 512 is at the rear 521 of the blade. The belly edge region 514 is frontward of the straight edge region 512.

In an example implementation, the blade belly is made of S90V for very high edge retention and the straight edge is made of 3V tool steel for extreme toughness for possible applications such as beating or batoning.

In one approach, the belly edge region 514 has a higher edge retention than the straight edge region 512.

FIG. 5B depicts a variation on the example knife 500 of FIG. 5A, where the belly edge region 514 of the blade has a different metal composition than the main body 560 of the blade, and a straight edge region 512A has a same material, e.g., a same metal composition, as the main body 560 of the blade, in accordance with various embodiments. This example indicates that only a portion of the blade edge (e.g., the belly edge region 514) can be treated to have a different composition than the main body of the blade. The straight edge region 512A is part of the main body 560 of the blade.

For example, the process can involve laser cutting the blade and then depositing a portion of the edge with another blade steel like CPM-M4, as an example. So, only one different blade steel would be deposited to the edge instead of two or more, with the second edge material being the same as the rest of the blade, e.g., standard steel such as S30V, also known as CPM S30V. S30V steel is a premium-grade stainless steel known for its toughness, wear resistance, and corrosion resistance. It includes 1.45% carbon, 14% chromium, 2% molybdenum, 4% vanadium, and 0.5% niobium.

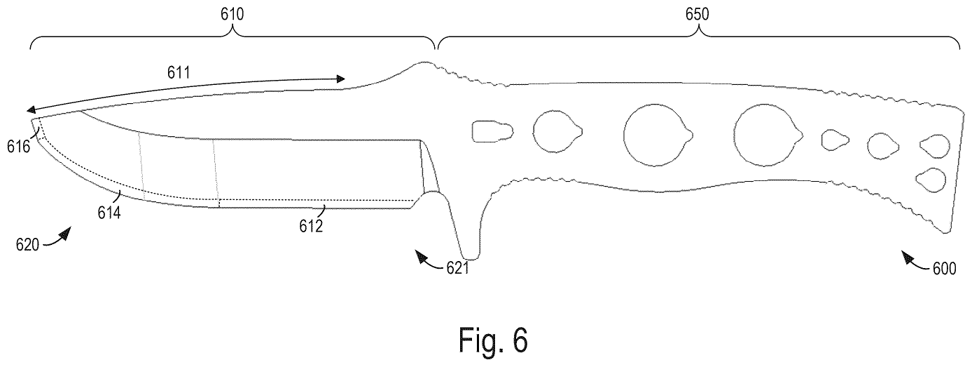

FIG. 6 depicts a sixth example knife 600 having a blade 610 with a straight edge region 612, a belly edge region 614 and a chisel tip edge region 616 with different metal compositions, and a handle 650, in accordance with various embodiments. The knife has a chisel tip for heavy chiseling use.

The blade includes the straight edge region 612, the belly edge region 614, and the chisel tip edge region 616 on the bottom side, and a spine 611 on the top side.

The chisel tip edge region 616 is at the front 620 of the blade, the straight edge region 612 is at the rear 621 of the blade, and the belly edge region 614 is between and adjacent to the edge regions 616 and 612. The chisel tip edge region 616 is frontward of the belly edge region 614, and the belly edge region 614 is frontward of the straight edge region 612. In an example implementation, the chisel tip is made of 3V tool steel for extreme toughness, the belly edge is made of S90V for very high edge retention, and the straight edge is made of M4 tool steel for high toughness and high edge retention.

In one approach, the chisel tip edge region 616 has a higher edge retention than the belly edge region 614, and the straight edge region 612 has a higher edge retention than the belly edge region 614.

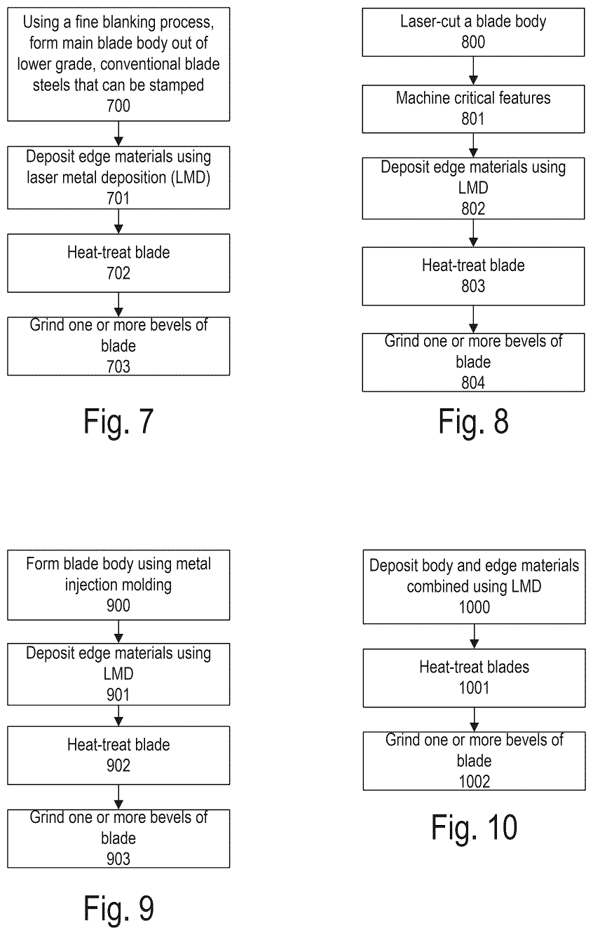

FIGS. 7-10 depict example manufacturing processes for knife blades, including those described herein.

FIG. 7 depicts a first example method for fabricating a knife blade with edge regions with different metal compositions. Step 700 includes, using a fine-blanking process, forming the main blade body out of lower grade, conventional steels that can be stamped.

Fine blanking (also known as fine-edge blanking) is a special type of stamping process that produces parts of enhanced accuracy, flatness, and edge characteristics compared to conventional stamping. An example of a lower grade, conventional steel is grade 420 (UNS S42000) stainless steel, a martensitic stainless steel.

Step 701 includes depositing edge materials using laser metal deposition (LMD). LMD is an additive manufacturing process where a high-powered laser beam is used to melt and fuse metal powder onto a substrate. This process is referred to as powdered metal laser deposition. The materials can be deposited along the edge and extend a specified distance from the edge such as a few millimeters. Step 702 includes heat-treating of the blade, e.g., heating it to a specific temperature, then rapidly cooling it, and finally reheating it to relieve stress. Step 703 includes grinding one or more bevels of the blade.

FIG. 8 depicts a second example method for fabricating a knife blade with edge regions with different metal compositions. Step 800 includes laser-cutting of the blade body. This can involve using a laser beam to cut a blade blank from a stainless steel sheet. Step 801 includes machining critical features. This can include using a computer numerical control (CNC) mill to shape the blade. Step 802 includes depositing edge materials using LMD. Step 803 includes heat-treating of the blade. Step 804 includes grinding one or more bevels of the blade.

FIG. 9 depicts a third example method for fabricating a knife blade with edge regions with different metal compositions. Step 900 includes forming the blade body using metal injection molding (MIM). MIM is a process where a metallic powder is mixed with a binder and injected into a mold. The binder sets, and a product is removed from the mold. The product is subjected to a series of steps in which the binder is removed and the powder portion is sintered to form a metal component in the desired shape. Step 901 includes depositing edge materials using LMD. Step 902 includes heat-treating of the blade. Step 903 includes grinding one or more bevels of the blade.

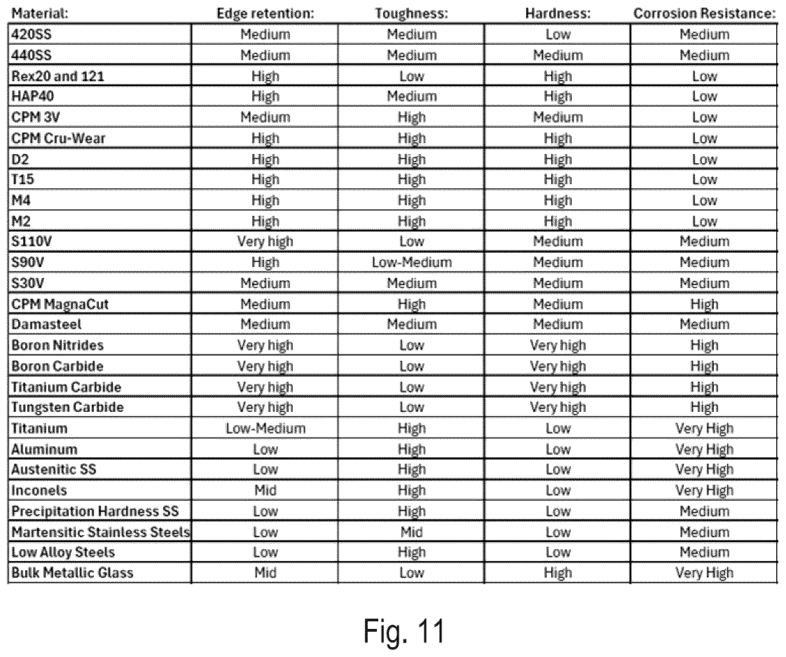

FIG. 10 depicts a fourth example method for fabricating a knife blade with edge regions with different metal compositions. Step 1000 includes depositing body and edge materials combined using LMD. Step 1001 includes heat-treating the blade. Step 1002 includes grinding one or more bevels of the blade. This technique can include 3D printing of the blade edges and other laser metal deposition and cladding techniques. The same post process steps can be used for both printing a total blade and printing a MIM base body.

In the fabrication methods, the thickness of the applied/secondary edge metal should be sufficient, e.g., 1-5 μm, to allow the blade to be resharpened. Additionally, the materials should be selected to optimize for specific use cases, such as discussed in connection with FIG. 11. The spreadsheet provides a matrix of materials and properties that can be aligned with certain use cases. Since the blade edge is split into two or more regions with different materials, each material can be selected for a different property/function and located on the blade in the area that is generally used or intended for that function.

FIG. 11 depicts a table of example knife blade materials with respective properties including edge retention, toughness, hardness, and corrosion resistance, in accordance with various embodiments.

Generally, a knife blade can be used for various example use cases including cutting, slicing, shaving, carving, and processing materials, ranging from everyday tasks to specialized uses in outdoor, culinary, industrial, and emergency contexts. Cutting soft materials typically requires hardness and edge retention, cutting hard or unpredictable materials typically requires toughness, and wet or acidic environments typically require corrosion resistance. Most knife tasks involve a tradeoff between the four properties of edge retention, toughness, hardness and corrosion resistance. Example compositions and use cases are discussed below.

### I. Steels and High-Performance Alloys

420 Stainless Steel (420SS)
   Type: Martensitic stainless.
   Composition: ~0.3-0.4% C, 12-14% Cr.
   Use Cases: Budget kitchen knives, hunting knives, and diving knives.
440 Stainless Steel (440A/B/C; 440SS)
   Type: Martensitic stainless.
   Composition: 0.6-1.2% C, 16-18% Cr.
   Use Cases: Folding knives, kitchen knives, and utility knives.
Rex 20 and Rex 121 (High-Speed Steels)
   Type: Powder Metallurgy (PM) high-speed steels.
   Rex 20: High cobalt, Mo, W; very hot-hard, good wear resistance.
   Rex 121: Ultra-high tungsten/cobalt; extremely high hardness (up to ~70 HRC).
   Use Cases: Industrial knives, cutting tools, and high-wear applications.
HAP40 (Hitachi PM High-Speed Steel)
   Composition: High carbon, high Co, Mo, V.
   Use Cases: Precision cutting tools, industrial knives, and high-wear blades.
CPM 3V
   Type: PM tool steel.
   Composition: High V (about 3%); moderate Cr.
   Use case: Heavy-duty survival knives, tactical knives, and outdoor knives.
CruWear (CPM Cru-Wear)
   Type: PM tool steel.
   Composition: High V (~2.4%); W; Mo; medium Cr.
   Use Cases: Long-lasting utility knives, industrial blades, and hunting knives.
D2
   Type: High-carbon, high-chromium tool steel.
   Composition: 1.5% C, 12% Cr, 1% V.
   Use Cases: Industrial knives, bushcraft knives, and sheet metal cutters.
T15 (High-Speed Steel)
   Composition: High W (12-13%), high V (~5%), some Co.
   Use Cases: Industrial cutting tools, woodworking knives.
M4 (Crucible Particle Metallurgy (CPM) and non-CPM versions).
   Type: High-speed tool steel.
   Composition: High Mo, W, V, relatively high C.
   Use Cases: Precision knives, high-end kitchen knives, and cutting tools.
M2
   Type: Standard high-speed steel.
   Composition: Mo—W—V; moderate C.
   Use Cases: Industrial cutting tools, and knives exposed to heat or abrasive materials.
S110V
   Type: PM stainless steel.
   Composition: Very high V (~9%); high Cr; Nb.
   Use Cases: High-end folding knives, EDC knives, and collectors'knives.
S90V
   Type: PM stainless steel.
   Composition: ~9% V, moderate Cr.
   Use Cases: High-end outdoor knives, and premium EDC knives.
S30V
   Type: PM stainless steel
   Composition: ~4% V, high Cr.
   Use Cases: EDC knives, tactical knives, and hunting knives.
CPM MagnaCut
   Type: PM stainless steel.
   Composition (simplified):
   ~1.15% Carbon
   ~10.7% Chromium
   ~4% Vanadium
   ~2% Molybdenum
   ~0.7% Niobium
   ~0.2% Nitrogen
   Use Cases: High-performance knives for EDC, outdoor, and tactical use.
Damasteel (Powder Metallurgy Damascus)
   Type: Stainless patterned steel.
   Composition: Layered PM steels (often RWL34+PMC27).
   Use Cases: Decorative knives, high-end kitchen knives, and limited-use collector blades.

### II. Ceramic and Carbide Materials

Boron Nitride (cBN/hBN)
   Type: Ceramic.
   Use Cases: Industrial cutting tools, abrasives, specialty ceramic knives.
Boron Carbide
   Use Cases: Abrasives, armor plating, and industrial cutting tools.
Tungsten Carbide
   Use Cases: Industrial cutting tools, stone cutting, and metal machining.

### III. Metals (Non-Steel)

Titanium
   Use Cases: Diving knives, lightweight EDC knives.
Aluminum
   Use Cases: Knife handles and lightweight blade cores (rarely cutting blades).

### IV. Steel Classes

Austenitic Stainless Steel
   Composition: High Cr, Ni; low carbon.
   Use Cases: Kitchen knives, diving knives, and corrosion-resistant tools.
Inconels (Ni-based Superalloys)
   Composition: High Ni; Cr; Mo; Nb
   Use Cases: Aerospace, and specialty knives in high-temperature environments.
Precipitation-Hardening Stainless Steel (PH SS)
   Examples: 17-4PH.
   Composition: Cr—Ni—Cu or Cr—Ni—Al.
   Use Cases: High-strength knives, surgical tools, and industrial knives.
Martensitic Stainless Steels
   Composition: Higher C (0.3-1.2%), Cr 12-18%.
   Use Cases: Kitchen knives, tactical knives, and utility knives.
Low Alloy Steels
   Composition: Small amounts of Ni, Mo, Cr, etc.
   Use Cases: Military knives, survival knives, and high-toughness applications.

### V. Amorphous/Advanced Alloys

Bulk Metallic Glass (BMG)
   Type: Amorphous metal.
   Use Cases: Specialty knives, and experimental high-performance cutting tools.

Various examples herein involve a blade in a hand held knife. However, the principles disclosed are applicable to other types of tools that use cutting blades.

Examples include construction and carpentry tools such as circular saws, table saws, miter saws, reciprocating saws, jigsaws, band saws, planers, routers (with cutting bits), utility shears/tin snips, and carbide-tipped masonry saws.

Additional examples include industrial and manufacturing tools such as lathe cutting tools, milling machine end mills/inserts, Computer Numerical Control (CNC) cutting inserts (carbide, cBN, etc.), industrial slitters (metal, paper, film), die cutters, press brake shear blades, granulator blades (plastic recycling), waterjet garnet nozzles (abrasive cutting), laser cutters (not blades, but cutting tools), and industrial shredders.

Additional examples include woodworking tools such as hand planes (replaceable steel irons), chisels, woodturning tools, spokeshaves, and carving gouges.

Additional examples include food processing tools such as meat slicers (rotary blades), food processors (chopping disks), mandolines, deli slicers, and industrial vegetable cutters.

Additional examples include textiles and paper cutting tools such as rotary cutters, paper guillotines, die-cutting machines, fabric shears, and mat cutters.

Additional examples include gardening and agriculture tools such as lawnmower blades, hedge trimmers, pruning shears, brush cutters/string trimmers (with blade heads), and combine harvester knives.

Additional examples include automotive and metalworking tools such as angle grinder cutting disks, cutoff wheels, pipe cutters, metal shears, and bolt cutters.

Additional examples include cosmetic/medical tools such as scalpels, dermaplaning blades, microtome blades (for tissue sectioning), and surgical saws.

Additional examples include packaging/utility tools such as box cutters, industrial tape/case cutters, and shrink-wrap slitter knives.

Additional examples include craft and hobby tools such as X Acto-style craft blades, scraper blades, rotary craft cutters, and vinyl plotter blades.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways.

This application is intended to cover any adaptations or variations of the embodiments discussed herein. Therefore, it is manifestly intended that embodiments be limited only by the claims and the equivalents thereof.

What is claimed is:

1. A knife, comprising:
a blade; and
a handle attached to the blade, wherein the blade comprises a cutting edge having different respective edge regions made of different respective materials, with different respective properties.

2. The knife of claim 1, wherein the different respective properties comprise at least one of different hardnesses, different toughness, different edge retentions, and different corrosion resistances.

3. The knife of claim 1, wherein the different respective materials comprise different respective single alloys.

4. The knife of claim 1, wherein the different edge regions include frontward and rearward edge regions, and a hardness of the frontward region is greater than a hardness of the rearward region.

5. The knife of claim 4, wherein the frontward edge region comprises S90V metal and the rearward edge region comprises 3V tool steel.

6. The knife of claim 4, wherein the frontward edge region comprises S90V metal and the rearward edge region comprises M4 tool steel.

7. The knife of claim 1, wherein the different respective edge regions include two adjacent edge regions.

8. The knife of claim 1, wherein the different respective edge regions include three adjacent edge regions.

9. The knife of claim 1, wherein the different edge regions include a belly edge and a straight edge.

10. The knife of claim 1, wherein the different edge regions include a first edge region including a tip of the blade and a top of the blade, and a second edge region including a concave edge at a bottom of the blade.

11. The knife of claim 1, wherein the different edge regions include a first edge region including a tanto tip of the blade, and a second edge region including a straight edge.

12. The knife of claim 1, wherein the different edge regions include a straight edge region, a belly edge region adjacent to the straight edge region, and a chisel tip edge region adjacent to the belly edge region.

13. The knife of claim 1, wherein the different respective edge regions have different geometries.

14. The knife of claim 1, wherein the different respective materials are different than a material of a main body of the blade.

15. The knife of claim 1, wherein at least one of the different respective edge regions has a same material as a main body of the blade.

16. The knife of claim 1, wherein the different respective materials are for different respective use cases.

17. A method for forming a knife blade, comprising:
forming a blade body using a fine-blanking process, laser-cutting, or injection molding; and
depositing different respective materials with different respective properties on different respective edge regions of a cutting edge of the blade body using laser metal deposition.

18. The method of claim 17, wherein the different respective properties comprise at least one of different hardnesses, different toughness, different edge retentions, and different corrosion resistances.

19. The method of claim 17, further comprising heat-treating the blade, and grinding one or more bevels of the blade.

20. The method of claim 17, further comprising depositing body and edge materials combined using laser metal deposition.
